(19) United States
(12) Patent Application Publication
(10) Pub. No.: US 2026/0120340 A1
(43) Pub. Date: Apr. 30, 2026

(54) IMAGE PROCESSING APPARATUS, CONTROL METHOD FOR IMAGE PROCESSING APPARATUS, AND STORAGE MEDIUM

(71) Applicant: CANON KABUSHIKI KAISHA, Tokyo (JP)

(72) Inventor: Emi KAWAI, Kanagawa (JP)

(21) Appl. No.: 19/367,887

(22) Filed: Oct. 24, 2025

(30) Foreign Application Priority Data
Oct. 31, 2024 (JP) 2024-192418

(51) Int. Cl. G06T 11/00; G06V 10/74

(52) U.S. Cl. CPC G06T 11/00; G06V 10/761; G06T 2200/24

(57) ABSTRACT

An image processing apparatus comprising: a conversion unit configured to convert an input image to acquire an output image; a calculation unit configured to calculate similarity between a first input image and a second input image; and a determination unit configured to determine whether or not the second input image is an image shot in an identical scene to the first input image based on the similarity, wherein the conversion unit converts the second input image to acquire a second output image by using data based on a first output image in which the first input image is converted by the conversion unit, in a case where the second input image is determined to be an image shot in the identical scene.

### BACKGROUND

### Field of the Technology

The present disclosure relates to an image processing apparatus, a control method for an image processing apparatus, and a storage medium.

### Description of the Related Art

In recent years, generative artificial intelligence (AI) technology has rapidly spread. In particular, in the field of image generation, a designated image and moving image can be easily generated, and therefore becoming more widely utilized in various fields such as corporate promotion and movie production in addition to individual content production.

In image generation by generative AI, Text to Image, which generates an image based on character input, and Image to Image, which generates an image based on image input, are known as representative patterns. Image generation by Image to Image can change a part of a subject of an input image and newly generate an angle of view that is not in the input image. At that time, it is possible to generate an image close to a user intention by inputting instruction data indicating desired change content together with the image.

However, since the generated image is generated by AI processing after all, the output result cannot be fully predicted. Even if exactly the same image and instruction data are input, the generation result can change between the first time and the second time. In a case where each image of a image group of a continuously shot identical scene is input to generative AI for the purpose of widening the angle of view or changing the color tone of the background, the position, size, appearance, color tone, brightness, and the like of a newly generated subject or background can result in inconsistency depending on the image. Therefore, there is a concern that consistency is lost when the output image is viewed as the entire scene. For example, in a case where an image group with several images in which a bird flying in the sky is shot is input to generative AI for the purpose of converting the sky from cloudy to clear, the position and size of the sun added to the sky can vary depending on the image.

As a method for suppressing variation in output results of image processing, Japanese Patent Laid-Open No. H10-290469 discloses determining white balance of current image data by performing weighting according to similarity between image data acquired in the past and latest image data. Japanese Patent Laid-Open No. 2013-192057 discloses a method for suppressing variation in brightness and color between images in image processing in which image capturing is continuously performed a plurality of times, such as AE bracketing and HDR shooting.

However, the technologies described in Japanese Patent Laid-Open No. H10-290469 and Japanese Patent Laid-Open No. 2013-192057 merely reduce variations in output results of image processing related to brightness and color tone, such as tone correction processing and white balance processing. For this reason, it is not possible to reduce variation with respect to image processing of performing image generation with randomness such as generative AI.

### SUMMARY

The present disclosure has been made in view of the above problem, and provides a technology for suppressing variation from occurring in output results of image generation.

According to one aspect of the present disclosure, there is provided an image processing apparatus comprising: a conversion unit configured to convert an input image to acquire an output image; a calculation unit configured to calculate similarity between a first input image and a second input image; and a determination unit configured to determine whether or not the second input image is an image shot in an identical scene to the first input image based on the similarity, wherein the conversion unit converts the second input image to acquire a second output image by using data based on a first output image in which the first input image is converted by the conversion unit, in a case where the second input image is determined to be an image shot in the identical scene.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view illustrating an example of a hardware configuration of an image processing apparatus according to one embodiment.

FIG. 2 is a view illustrating an example of a functional configuration of the image processing apparatus according to the first embodiment.

FIG. 3 is an operation explanatory view of the image processing apparatus according to the first embodiment.

FIG. 4 is a flowchart showing a procedure of processing performed by the image processing apparatus according to the first embodiment.

FIG. 5 is a view illustrating an example of a functional configuration of the image processing apparatus according to a second embodiment.

FIG. 6 is an operation explanatory view of the image processing apparatus according to the second embodiment.

FIG. 7 is a flowchart showing a procedure of processing performed by the image processing apparatus according to the second embodiment.

FIG. 8 is a view illustrating an example of a functional configuration of the image processing apparatus according to a third embodiment.

FIG. 9 is an operation explanatory view of the image processing apparatus according to the third embodiment.

FIG. 10 is a flowchart showing a procedure of processing performed by the image processing apparatus according to the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Hardware Configuration

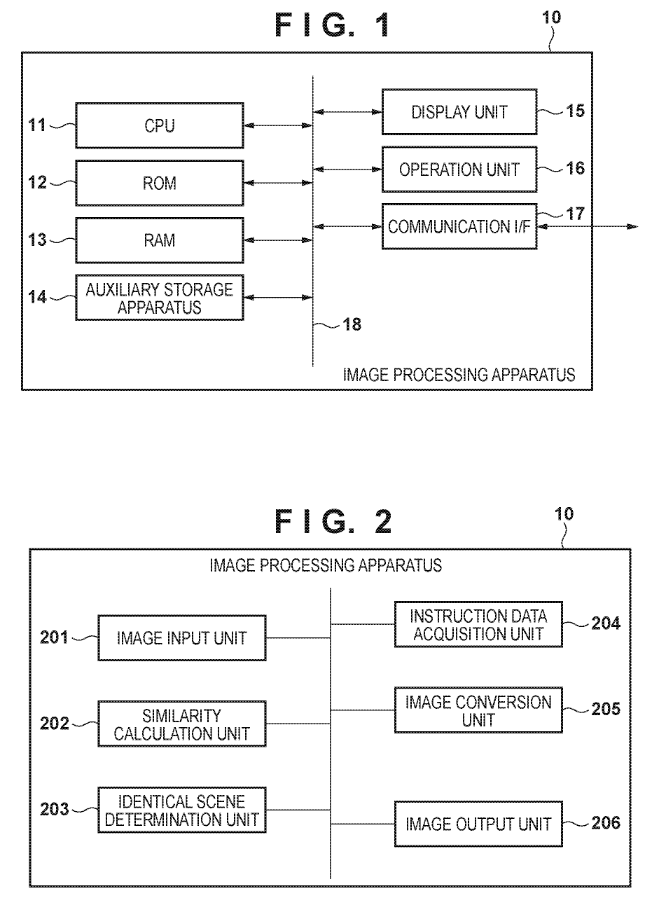

First, an example of the hardware configuration of an image processing apparatus according to the present embodiment will be described with reference to FIG. 1. An image processing apparatus 10 includes a central processing unit (CPU) 11, a read only memory (ROM) 12, a random access memory (RAM) 13, an auxiliary storage apparatus 14, a display unit 15, an operation unit 16, a communication I/F 17, and a bus 18.

The CPU 11 implements each function of the image processing apparatus 10 illustrated in FIG. 1 by controlling the entire image processing apparatus 10 using computer programs and data stored in the ROM 12 and the RAM 13. Note that the image processing apparatus 10 may include one piece or a plurality of pieces of dedicated hardware different from the CPU 11, and at least part of the processing by the CPU 11 may be executed by the dedicated hardware. Examples of the dedicated hardware include an application specific integrated circuit (ASIC), a field programmable gate array (FPGA), and a digital signal processor (DSP). The ROM 12 stores programs and the like that do not need to be changed. The RAM 13 temporarily stores programs and data supplied from the auxiliary storage apparatus 14, data supplied externally via the communication I/F 17, and the like. The auxiliary storage apparatus 14 includes, for example, a hard disk drive, and stores various data such as image data and audio data.

The display unit 15 includes, for example, a liquid crystal display or an LED, and displays a graphical user interface (GUI) or the like for the user to operate the image processing apparatus 10. The operation unit 16 includes, for example, a keyboard, a mouse, a joystick, and a touch panel, and inputs various instructions to the CPU 11 in response to an operation by a user. The communication I/F 17 is used for communication with an apparatus external to the image processing apparatus 10. For example, in a case where the image processing apparatus 10 is connected to an external apparatus by wire, a communication cable is connected to the communication I/F 17. In a case where the image processing apparatus 10 has a function of wirelessly communicating with an external apparatus, the communication I/F 17 includes an antenna. The bus 18 connects each unit of the image processing apparatus 10 to transmit information.

The present embodiment assumes that the display unit 15 and the operation unit 16 exist inside the image processing apparatus 10, but at least one of the display unit 15 and the operation unit 16 may exist as another apparatus external to the image processing apparatus 10. In this case, the CPU 11 may operate as a display control unit that controls the display unit 15 and an operation control unit that controls the operation unit 16.

### Functional Configuration

Next, an example of the functional configuration of the image processing apparatus according to the present embodiment will be described with reference to FIG. 2. The image processing apparatus 10 includes an image input unit 201, a similarity calculation unit 202, an identical scene determination unit 203, an instruction data acquisition unit 204, an image conversion unit 205, and an image output unit 206.

The image input unit 201 acquires an input image. Here, the input image is an image acquired by a digital camera, a smartphone, a tablet terminal, or any other apparatus that can shoot, and is one of an image group shot in an identical scene, for example.

The similarity calculation unit 202 calculates similarity between an input image input to the image input unit 201 in the previous processing by generative AI and an input image input to the image input unit 201 in the present processing by generative AI. The similarity can be calculated based on information regarding the image capturing time of the previous input image and the image capturing time of the present input image and/or an arbitrary statistic obtained from the previous input image and an arbitrary statistic obtained from the present input image. For example, the similarity may be calculated based on a difference in image capturing time between images. A statistic of luminance values of images may be compared as the statistic, and the similarity may be calculated based on the difference thereof. Furthermore, the similarity may be calculated using an existing method as disclosed in Japanese Patent Laid-Open No. H10-290469 and Japanese Patent Laid-Open No. 2013-192057.

The identical scene determination unit 203 determines whether or not the previous input image and the present input image are images shot in an identical scene based on the similarity calculated by the similarity calculation unit 202. For example, in a case where the similarity calculated by the similarity calculation unit 202 is equal to or more than a threshold, it can be determined that the previous input image and the present input image are images shot in the identical scene.

The instruction data acquisition unit 204 acquires instruction data indicating conversion content desired by the user. The instruction data is data indicating a user's request regarding a change in the input image, and is what is called a prompt. For example, the instruction data may be text information such as "clear blue sky" or "sun and cloud". By inputting such instruction data as a prompt in a case where a bird appears in an input image, it is possible to generate an image in which the background is converted into a clear blue sky with the bird as it is in a case where a bird flying in a cloudy sky appears in the input image.

Based on the determination result of the identical scene determination unit 203, the image conversion unit 205 performs image conversion of the input image using the instruction data acquired by the instruction data acquisition unit 204 or using the output image itself generated in the previous processing. Details of the processing of the image conversion unit 205 will be described later. Note that the image conversion processing according to the present embodiment assumes processing of converting, using generative AI, at least a part of the input image and performing image generation with randomness. Examples of processing of converting at least a part include various examples of changing the size, shape, color, brightness, and the like of the subject appearing in an input image, deleting or newly adding an arbitrary subject, and changing a background of an image. Other examples include an example in which the angle of view of an input image is increased to generate an angle of view portion that has not existed, and an output image is created.

The image output unit 206 outputs, to the display unit 15 and the like, the output image converted and generated by the image conversion unit 205.

### Description of Processing

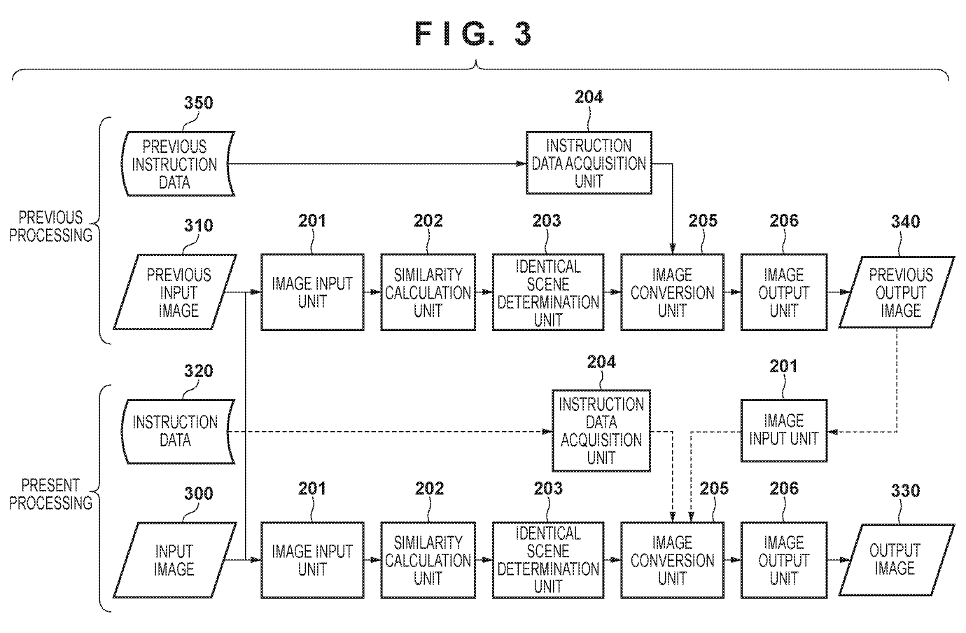

Here, a flow of processing of the image processing apparatus 10 described in FIG. 2 will be described in detail with reference to FIG. 3. The upper part of FIG. 3 represents the previous processing, and the lower part represents the present processing. In the previous processing, a previous input image 310 is input to the image input unit 201 and acquired by the similarity calculation unit 202. Here, the similarity between the previous input image 310 and an input image the time before last is calculated. Then, it is assumed that the identical scene determination unit 203 determines that the previous input image 310 and the input image the time before last are not images shot in the identical scene. In that case, the image conversion unit 205 performs image conversion based on previous instruction data 350 acquired by the instruction data acquisition unit 204, and the image output unit 206 outputs a previous output image 340.

Then, in the present processing, a present input image 300 is input to the image input unit 201 and is acquired by the similarity calculation unit 202. At that time, the previous input image 310 is also input to the image input unit 201, and is acquired by the similarity calculation unit 202. The similarity calculation unit 202 determines similarity between the present input image 300 and the previous input image 310. Then, in a case where the identical scene determination unit 203 determines that the present input image 300 and the previous input image 310 are not images shot in the identical scene, the instruction data acquisition unit 204 acquires instruction data 320 instructing the conversion content desired by the user. Then, the image conversion unit 205 performs image conversion based on the instruction data 320 acquired by the instruction data acquisition unit 204, and the image output unit 206 outputs an output image 330.

On the other hand, in a case where the identical scene determination unit 203 determines that the present input image 300 and the previous input image 310 are images shot in the identical scene, the input with respect to the image conversion unit 205 is switched. Specifically, the previous output image 340 is input as a substitute for the instruction data 320. The image conversion unit 205 performs image conversion by using the previous output image 340 as a substitute for a prompt, and the image output unit 206 outputs the output image 330. Use of the previous output image 340 as a substitute for a prompt results in similar conversion content (the position of the sun in the image, the degree of blue sky, and the like are similar) also in the present output image 330, for example, in a case where the previous output image 340 is a bird image with the background converted into a clear blue sky.

Even if the same instruction data (prompt) is used every time, for example, even if the instruction data is the same "clear blue sky" both the previous time and the present time, there is a case where the position of the sun in the output image is different between the previous time and the present time, or the color tone of the blue sky is different. On the other hand, use of the previous output image 340 as a prompt can suppress such variation in generation results. Therefore, for example, in a case where image conversion is performed on an image group of the identical scene obtained by continuously shooting a flying bird, it is possible to reduce consistency from being lost due to variations in the position of the sun, the position of the cloud, the clearness of the sky, the color of the sky, and the like for each image.

### Processing Flow

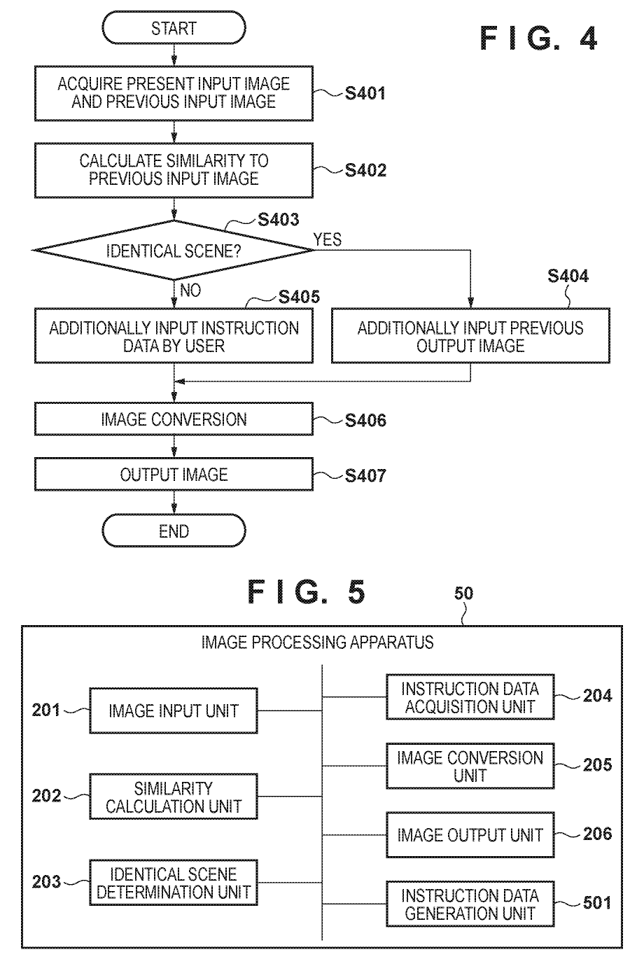

FIG. 4 is a flowchart showing a procedure of processing performed by the image processing apparatus according to the present embodiment. The processing according to the present embodiment is implemented by the CPU 11 reading and executing a computer program stored in the ROM 12 or the RAM 13 to execute each function of the functional block diagram of the image processing apparatus 10 described in FIG. 2.

In S401, the image input unit 201 acquires the present input image 300 and the previous input image 310. In S402, the similarity calculation unit 202 calculates the similarity between the present input image 300 and the previous input image 310.

In S403, the identical scene determination unit 203 determines whether or not the present input image 300 and the previous input image 310 are images shot in an identical scene. In a case where the identical scene determination unit 203 determines that they are images shot in the identical scene, the process proceeds to S404. On the other hand, in a case where the identical scene determination unit 203 determines that they are not images shot in the identical scene, the process proceeds to S405.

In S404, the image input unit 201 acquires the previous output image 340. In S405, the instruction data acquisition unit 204 acquires the instruction data 320 indicating the conversion content desired by the user.

In S406, the image conversion unit 205 performs image conversion on the present input image 300. In a case where it is determined in S403 that they are not images shot in the identical scene, the image conversion unit 205 performs image conversion based on the instruction data 320 acquired by the instruction data acquisition unit 204. On the other hand, in a case where it is determined in S403 that they are images shot in the identical scene, the image conversion unit 205 performs image conversion using the previous output image 340 as a substitute for a prompt in place of the instruction data 320.

In S407, the image output unit 206 outputs the output image 330 subjected to the image conversion in S406. The above is the series of processes in FIG. 4.

As described above, according to the present embodiment, in a case where image processing of performing image generation with randomness is applied to an image group shot in an identical scene, it is possible to reduce variation in output results.

### Second Embodiment

In the present embodiment, an example in which image conversion is performed by not using the previous output image as it is as a prompt but generating instruction data from a previous output image and using the generated instruction data as a prompt will be described. Since the hardware configuration of the image processing apparatus according to the present embodiment is similar to that of the first embodiment, the description thereof will be omitted.

### Functional Configuration

An example of the functional configuration of the image processing apparatus according to the present embodiment will be described with reference to FIG. 5. An image processing apparatus 50 further includes an instruction data generation unit 501 in addition to the image input unit 201, the similarity calculation unit 202, the identical scene determination unit 203, the instruction data acquisition unit 204, the image conversion unit 205, and the image output unit 206 described in the first embodiment.

The instruction data generation unit 501 automatically generates generation instruction data from the previous output image. The generation instruction data is instruction data including an image change instruction for ensuring consistency of the output image subjected to image conversion from the present input image with the previous output image. For example, instruction data designating in detail the position and size of the sun, the color tone of the blue sky, the shape of the cloud, and the like may be generated.

### Description of Processing

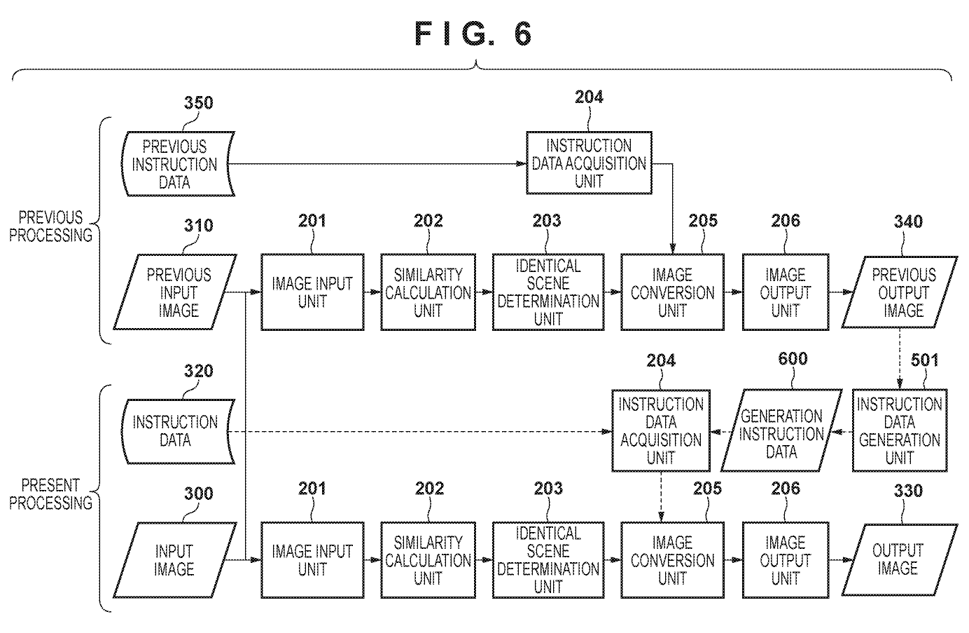

Here, a flow of processing of the image processing apparatus 50 described in FIG. 5 will be described in detail with reference to FIG. 6. The upper part of FIG. 5 represents the previous processing, and the lower part represents the present processing. In the previous processing, a previous input image 310 is input to the image input unit 201 and acquired by the similarity calculation unit 202. Here, the similarity between the previous input image 310 and an input image the time before last is calculated. Then, it is assumed that the identical scene determination unit 203 determines that the previous input image 310 and the input image the time before last are not images shot in the identical scene. In that case, the image conversion unit 205 performs image conversion based on the previous instruction data 350 acquired by the instruction data acquisition unit 204, and the image output unit 206 outputs the previous output image 340. The process so far is similar to that in FIG. 3, but in the present embodiment, thereafter, the instruction data generation unit 501 acquires the previous output image 340 and generates generation instruction data 600 based on the previous output image 340.

Then, in the present processing, the present input image 300 is input to the image input unit 201 and is acquired by the similarity calculation unit 202. At that time, the previous input image 310 is also input to the image input unit 201, and is acquired by the similarity calculation unit 202. The similarity calculation unit 202 determines similarity between the present input image 300 and the previous input image 310. Then, in a case where the identical scene determination unit 203 determines that the present input image 300 and the previous input image 310 are not images shot in the identical scene, the instruction data acquisition unit 204 acquires the instruction data 320 instructing the conversion content desired by the user. Then, the image conversion unit 205 performs image conversion based on the instruction data 320 acquired by the instruction data acquisition unit 204, and the image output unit 206 outputs the output image 330. The process so far is similar to that in FIG. 3.

On the other hand, in a case where the identical scene determination unit 203 determines that the present input image 300 and the previous input image 310 are images shot in the identical scene, the input with respect to the image conversion unit 205 is switched. Specifically, the generation instruction data 600 acquired by the instruction data acquisition unit 204 is input.

The image conversion unit 205 performs image conversion by using the generation instruction data 600 as a prompt, and the image output unit 206 outputs the output image 330. Use of the generation instruction data 600 as a prompt results in similar conversion content (e.g., the position of the sun in the image, the degree of blue sky, and the like are similar) also in the present output image 330, for example, in a case where the previous output image 340 is a bird image with the background converted into a clear blue sky. Use of the generation instruction data 600 generated from the previous output image 340 as a prompt can suppress variation in generation results.

### Processing Flow

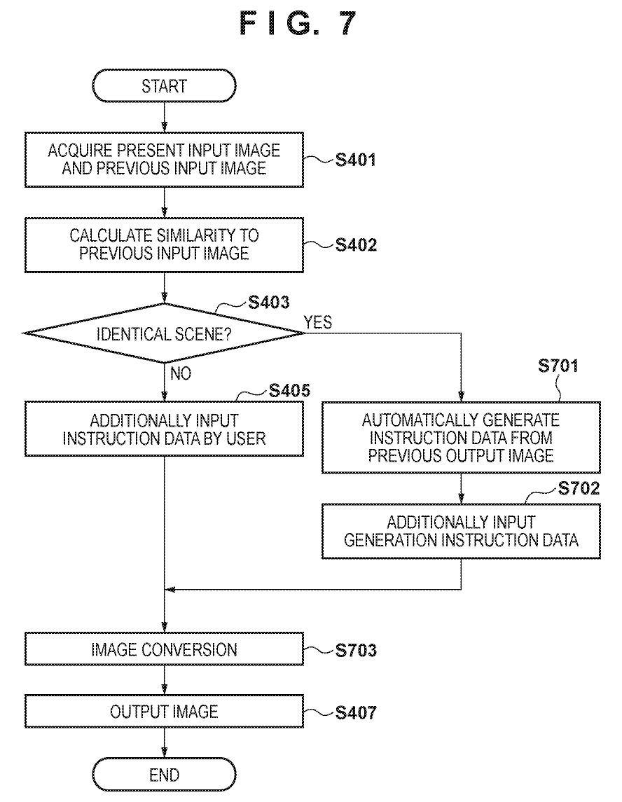

FIG. 7 is a flowchart showing a procedure of processing performed by the image processing apparatus according to the present embodiment. The same step number is given to the same processing as that described with reference to FIG. 4, and the detailed description thereof will be omitted. The processing according to the present embodiment is implemented by the CPU 11 reading and executing a computer program stored in the ROM 12 or the RAM 13 to execute each function of the functional block diagram of the image processing apparatus 50 described in FIG. 5.

In the present embodiment, in a case where the identical scene determination unit 203 determines in S403 that they are not images shot in the identical scene, the process proceeds to S701. In S701, the instruction data generation unit 501 acquires the previous output image 340, and generates the generation instruction data 600 based on the previous output image 340. In S702, the instruction data acquisition unit 204 acquires the generation instruction data 600 generated by the instruction data generation unit 501. Thereafter, the process proceeds to S703.

In S703, the image conversion unit 205 performs image conversion on the present input image 300. In a case where it is determined in S403 that they are not images shot in the identical scene, the image conversion unit 205 performs image conversion based on the instruction data 320 acquired by the instruction data acquisition unit 204. On the other hand, in a case where it is determined in S403 that they are images shot in the identical scene, the image conversion unit 205 performs image conversion using the generation instruction data 600 generated from the previous output image 340 as a prompt in place of the instruction data 320.

As described above, in the present embodiment, in a case of the identical scene, the instruction data (prompt) is generated from the output image that is the previous generation result, and image conversion is performed using the generated instruction data. This can reduce variation in output results in a case where image processing of performing image generation with randomness is applied to an image group shot in an identical scene.

### Third Embodiment

In the present embodiment, an example in which image conversion is performed by not using the previous output image as it is as a prompt but generating depth information from a previous output image and using the generated depth data as a prompt will be described. Since the hardware configuration of the image processing apparatus according to the present embodiment is similar to that of the first embodiment, the description thereof will be omitted.

### Functional Configuration

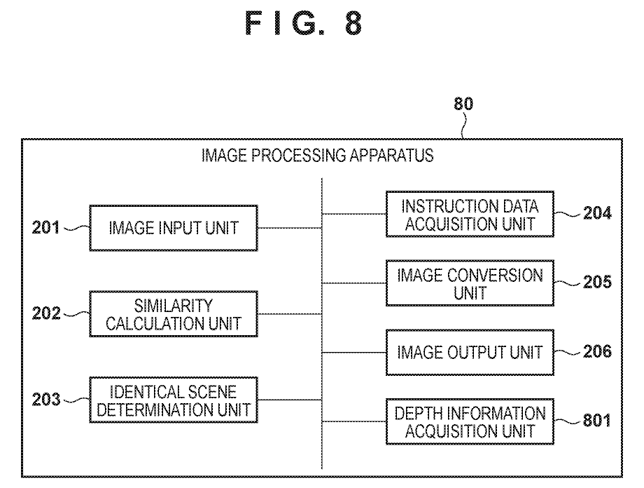

An example of the functional configuration of the image processing apparatus according to the present embodiment will be described with reference to FIG. 8. An image processing apparatus 80 further includes a depth information acquisition unit 801 in addition to the image input unit 201, the similarity calculation unit 202, the identical scene determination unit 203, the instruction data acquisition unit 204, the image conversion unit 205, and the image output unit 206 described in the first embodiment.

The depth information acquisition unit 801 acquires depth data 900 from the previous output image 340. Use of depth data (depth map) at the time of image conversion can maintain the shape and positional relationship of the subject. The depth data 900 includes information for matching the positional relationship of the subject in a conversion region in the output image 330, which is an image conversion result of the present input image 300, with the positional relationship of the previous output image 340. The depth data 900 may be acquired from the previous output image 340 itself or may be acquired based on the metadata of the previous output image 340 or the like.

### Description of Processing

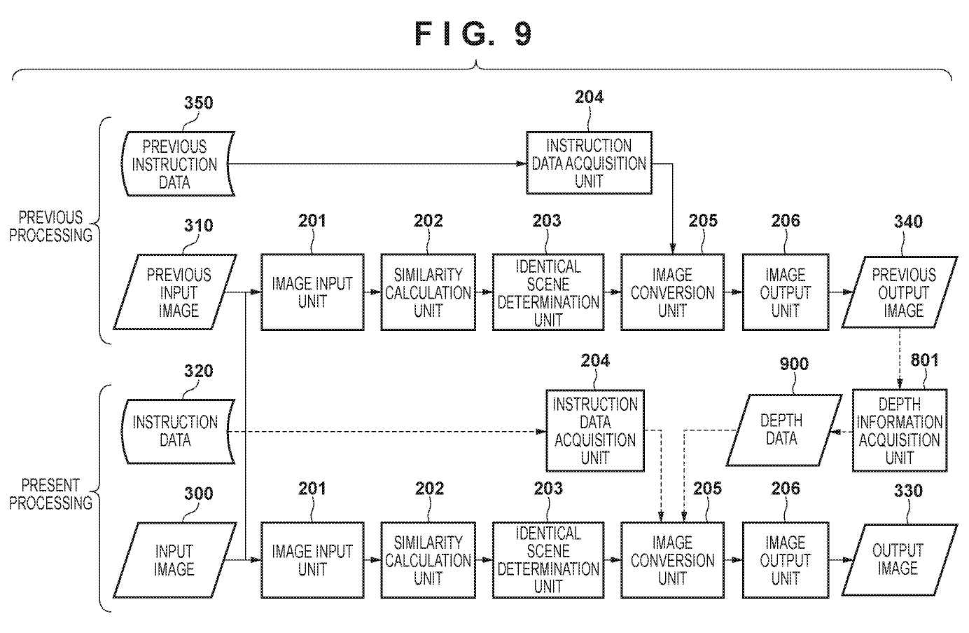

Here, a flow of processing of the image processing apparatus 80 described in FIG. 8 will be described in detail with reference to FIG. 9. The upper part of FIG. 9 represents the previous processing, and the lower part represents the present processing. In the previous processing, a previous input image 310 is input to the image input unit 201 and acquired by the similarity calculation unit 202. Here, the similarity between the previous input image 310 and an input image the time before last is calculated. Then, it is assumed that the identical scene determination unit 203 determines that the previous input image 310 and the input image the time before last are not images shot in the identical scene. In that case, the image conversion unit 205 performs image conversion based on the previous instruction data 350 acquired by the instruction data acquisition unit 204, and the image output unit 206 outputs the previous output image 340. The process so far is similar to that in FIG. 3, but in the present embodiment, thereafter, the depth information acquisition unit 801 acquires the previous output image 340 and generates the depth data 900 based on the previous output image 340.

Then, in the present processing, the present input image 300 is input to the image input unit 201 and is acquired by the similarity calculation unit 202. At that time, the previous input image 310 is also input to the image input unit 201, and is acquired by the similarity calculation unit 202. The similarity calculation unit 202 determines similarity between the present input image 300 and the previous input image 310. Then, in a case where the identical scene determination unit 203 determines that the present input image 300 and the previous input image 310 are not images shot in the identical scene, the instruction data acquisition unit 204 acquires the instruction data 320 instructing the conversion content desired by the user. Then, the image conversion unit 205 performs image conversion based on the instruction data 320 acquired by the instruction data acquisition unit 204, and the image output unit 206 outputs the output image 330. The process so far is similar to that in FIG. 3.

On the other hand, in a case where the identical scene determination unit 203 determines that the present input image 300 and the previous input image 310 are images shot in the identical scene, the input with respect to the image conversion unit 205 is switched. Specifically, the depth data 900 acquired by the depth information acquisition unit 801 is input.

The image conversion unit 205 performs image conversion by using the depth data 900 as a substitute for a prompt, and the image output unit 206 outputs the output image 330. Use of the depth data 900 as a substitute for a prompt results in similar conversion content (e.g., the position of the sun in the image is similar) also in the present output image 330, for example, in a case where the previous output image 340 is a bird image with the background converted into a clear blue sky. Use of the depth data 900 generated from the previous output image 340 as a prompt can result in a similar positional relationship of the subject, and therefore it is possible to suppress variation in generation results.

### Processing Flow

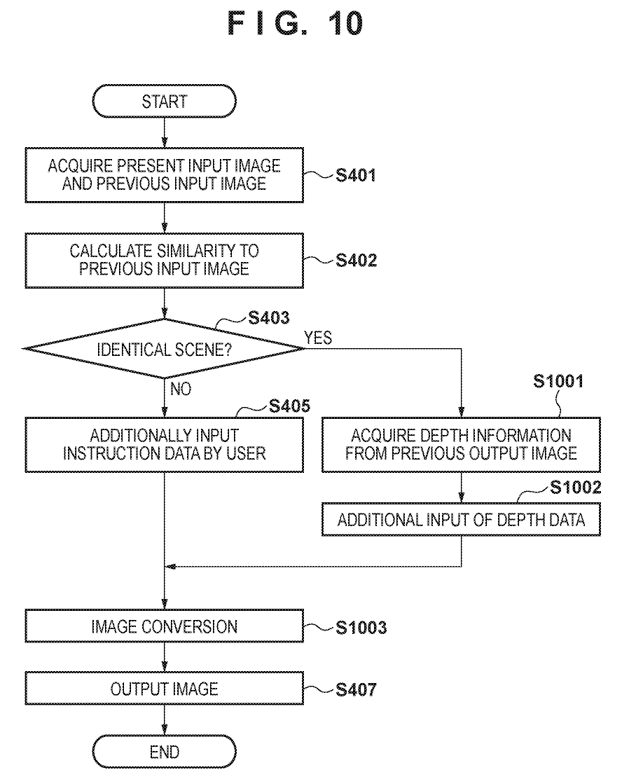

FIG. 10 is a flowchart showing a procedure of processing performed by the image processing apparatus according to the present embodiment. The same step number is given to the same processing as that described with reference to FIG. 4, and the detailed description thereof will be omitted. The processing according to the present embodiment is implemented by the CPU 11 reading and executing a computer program stored in the ROM 12 or the RAM 13 to execute each function of the functional block diagram of the image processing apparatus 80 described in FIG. 8.

In the present embodiment, in a case where the identical scene determination unit 203 determines in S403 that they are not images shot in the identical scene, the process proceeds to S1001. In S1001, the depth information acquisition unit 801 acquires the previous output image 340 and generates the depth data 900 based on the previous output image 340. In S1002, the instruction data acquisition unit 204 acquires the generation instruction data 600 generated by the instruction data generation unit 501. Thereafter, the process proceeds to S1003.

In S1003, the image conversion unit 205 performs image conversion on the present input image 300. In a case where it is determined in S403 that they are not images shot in the identical scene, the image conversion unit 205 performs image conversion based on the instruction data 320 acquired by the instruction data acquisition unit 204. On the other hand, in a case where it is determined in S403 that they are images shot in the identical scene, the image conversion unit 205 performs image conversion using the depth data 900 acquired from the previous output image 340 in place of the instruction data 320.

As described above, in the present embodiment, in a case of the identical scene, the depth data (prompt) is generated from the output image that is the previous generation result, and image conversion is performed using the generated depth data. This can reduce variation in output results in a case where image processing of performing image generation with randomness is applied to an image group shot in an identical scene.

### Variation Example

The identical scene determination processing of the first to third embodiments described above may be in a form that enables switching as to whether or not to execute the processing after adding a processing execution condition. That is, the identical scene determination processing may be performed in a case where a predetermined condition is satisfied. For example, a form of executing processing only in a case where the user desires, a form of executing processing limited to an image shot in an arbitrary shooting mode such as image data at the time of continuous shooting, and the like are applicable. For a case where the user desires, for example, in a case where an input instructing to execute identical scene determination processing is received from the user, the process may be executed.

In the first to third embodiments, the image processing apparatus has been described as an example, but the present disclosure can be carried out in any electronic device. Personal computers, tablet terminals, mobile phones, smartphones, digital cameras, digital video cameras, and the like can also be included. Furthermore, transmissive goggles used in game consoles, augmented reality (AR), mixed reality (MR), and the like are also included, but the present disclosure is not limited to them. In particular, in a case where the present disclosure is applied to a device that can shoot by an apparatus main body such as a digital camera or a mobile phone, the present disclosure can be applied not only as post-editing processing of an image but also to a form in which a shot image and an output result of the image conversion unit are simultaneously recorded at the time of shooting.

In the above-described embodiments, an example of calculating the similarity between the present input image and the previous input image has been described, but the present disclosure is not limited to this example. The similarity between the present input image and an input image shot before the present input image may be calculated. That is, the input image is not limited to the previous input image, and an input image before the previous input image may be used.

According to the above-described embodiments, in a case where it is determined that images are shot in an identical scene, the present input image is converted to acquire the present output image by using data based on the previous output image in which the previous input image is converted. This can reduce variation in the position, size, appearance, color tone, brightness, and the like of a newly generated subject or background in an output image in a case where image conversion is applied to an image group shot in an identical scene.

According to the present disclosure, it is possible to suppress variation from occurring in output results of image generation.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-192418, filed October 31, 2024, which is hereby incorporated by reference herein in its entirety.

What is claimed is:

1. An image processing apparatus comprising:
a conversion unit configured to convert an input image to acquire an output image;
a calculation unit configured to calculate similarity between a first input image and a second input image; and
a determination unit configured to determine whether or not the second input image is an image shot in an identical scene to the first input image based on the similarity, wherein
the conversion unit converts the second input image to acquire a second output image by using data based on a first output image in which the first input image is converted by the conversion unit, in a case where the second input image is determined to be an image shot in the identical scene.

2. The image processing apparatus according to claim 1, wherein in a case where the second input image is determined not to be an image shot in the identical scene, the conversion unit converts the second input image to acquire a second output image using instruction data indicating a user's request regarding a change in an input image.

3. The image processing apparatus according to claim 1, wherein the data based on the first output image is the first output image itself, instruction data regarding a change in an input image generated from the first output image, or depth data acquired from the first output image.

4. The image processing apparatus according to claim 3, wherein the instruction data regarding a change in an input image generated from the first output image indicates an image change instruction so as to ensure consistency of the second output image with the first output image.

5. The image processing apparatus according to claim 1, wherein the determination unit performs a determination in a case where a predetermined condition is satisfied.

6. The image processing apparatus according to claim 5, wherein the case where a predetermined condition is satisfied includes receiving, from a user, an input instructing to perform a determination.

7. The image processing apparatus according to claim 5, wherein the case where a predetermined condition is satisfied includes the second input image and the first input image being images acquired by continuous shooting.

8. The image processing apparatus according to claim 1, wherein the first input image is an image shot before the second input image.

9. The image processing apparatus according to claim 2, wherein the instruction data is a prompt.

10. The image processing apparatus according to claim 1, wherein the conversion unit performs image conversion with randomness.

11. The image processing apparatus according to claim 1, wherein the conversion unit performs image conversion using generative AI.

12. A control method for an image processing apparatus that converts an input image to acquire an output image, the control method comprising:
calculating similarity between a first input image and a second input image;
determining whether or not the second input image is an image shot in an identical scene to the first input image based on the similarity; and
converting the second input image to acquire a second output image by using data based on a first output image in which the first input image is converted, in a case where the second input image is determined to be an image shot in the identical scene.

13. A non-transitory computer-readable storage medium storing a program for causing a computer to execute a control method for an image processing apparatus that converts an input image to acquire an output image, the control method including
calculating similarity between a first input image and a second input image,
determining whether or not the second input image is an image shot in an identical scene to the first input image based on the similarity, and
converting the second input image to acquire a second output image by using data based on a first output image in which the first input image is converted, in a case where the second input image is determined to be an image shot in the identical scene.
